(19) United States
(12) Patent Application Publication
(10) Pub. No.: US 2020/0258028 A1
(43) Pub. Date: Aug. 13, 2020

(54) METHODS AND APPARATUS FOR FACILITATING TASK EXECUTION USING A DRONE

(71) Applicant: Intel Corporation, Santa Clara, CA (US)

(72) Inventors: DANIEL POHL, PUCHHEIM (DE); STEFAN MENZEL, STOCKDORF (DE); JULIUS BULLINGER, MUENCHEN (DE)

(21) Appl. No.: 16/643,337

(22) PCT Filed: Sep. 29, 2017
(86) PCT No.: PCT/US2017/054495

§ 371 Date: Feb. 28, 2020

(51) Int. Cl. G06Q 10/06; B64C 39/02; G06K 9/62; G06T 17/05

(52) U.S. Cl. CPC G06Q 10/063114; B64C 39/024; B64C 2201/123; G06T 17/05; G06K 9/6215; G06K 9/6265

(57) ABSTRACT

Methods, apparatus, systems, and articles of manufacture for facilitating task execution using a drone are disclosed. An example method includes accessing a result of a task performed by a task executor. The result includes one or more images of a task objective captured by the task executor. The result is validated based on a task definition provided by a task issuer. In response to the validation of the result indicating that the result complies with the task definition, the result is provided to the task issuer, and a reward is issued to the task executor.

### FIELD OF THE DISCLOSURE

This disclosure relates generally to task execution, and, more particularly, to methods and apparatus for facilitating task execution using a drone.

### BACKGROUND

In recent years, unmanned aerial vehicles (UAVs), also referred to as drones, have been used for tasks like mapping. A drone can be flown over a region and capture images of the region. Using the captured images, two-dimensional maps, and, in some examples, three-dimensional models, can be created. Such maps and/or models may be used for analysis of the region.

### BRIEF DESCRIPTION OF THE DRAWINGS

FIG. 1 is a diagram of an example drone capturing images of a region for the creation of a two-dimensional map.

FIG. 2 is a diagram of an example drone capturing images of a structure for the creation of a three-dimensional model.

FIG. 3 is a block diagram of an example environment of use including a task execution facilitation system.

FIG. 4 is a flowchart representative of example machine-readable instructions that may be executed to implement the example task execution facilitation system of FIG. 3 to receive a task definition from a task issuer.

FIG. 5 is a flowchart representative of example machine-readable instructions that may be executed to implement the example task execution facilitation system of FIG. 3 to allocate a task to a task executor.

FIG. 6 is a flowchart representative of example machine-readable instructions that may be executed to implement the example task executor of FIG. 3 to provide a result of a completed task to the example task execution facilitation system of FIG. 3.

FIG. 7 is a flowchart representative of example machine-readable instructions that may be executed to implement the example task executor of FIG. 3 to provide a result of a completed task to the example task execution facilitation system of FIG. 3.

FIG. 8 is a flowchart representative of example machine-readable instructions that may be executed to implement the example task execution facilitation system of FIG. 3 to analyze the result of the task.

FIG. 9 is a flowchart representative of example machine-readable instructions that may be executed to implement the example task execution facilitation system of FIG. 3 to validate the result of the task.

FIG. 10 is a block diagram of an example processing platform structured to execute the instructions of FIGS. 4, 5, 8 and/or 9 to implement the example task execution facilitation system of FIG. 3.

The figures are not to scale. Wherever possible, the same reference numbers will be used throughout the drawing(s) and accompanying written description to refer to the same or like parts.

### DETAILED DESCRIPTION

In recent years, unmanned aerial vehicles (UAVs), also referred to as drones, have been used for tasks like aerial photography, mapping, model creation, etc. A drone can be flown over and/or about a region/structure and capture images of the region/structure. Using the captured images, two-dimensional maps, and, in some examples, three-dimensional models, can be created. Such maps and/or models may be used for analysis of the region/structure. In some examples, such images, maps, and/or models may be used by publicly available mapping services (e.g., Google Maps), and/or by private entities (e.g., realtors, farmers, maintenance personnel, etc.).

In some examples, the entities that utilize such images, maps, and/or models undertake great effort to collect such images including, for example, purchasing a drone, learning how to operate the drone, operating the drone to collect images, processing those images, etc. Such entities seek individual drone operators (e.g., users who may already own a drone, users who may already be experienced drone pilots) to perform such tasks and provide images, maps, and/or models of an objective. For example, a realtor might desire a three-dimensional model of a property for listing, maintenance personnel may desire a three-dimensional model of a structure to confirm that no damage has been caused, an insurance adjustor might desire a three-dimensional model of a home before approving an insurance claim, etc. In some examples, the images, maps, and/or models, may be repeated over time. For example, a farmer might desire a two-dimensional map of their farm to be created every week to better understand the changing conditions of the farm.

Example approaches disclosed herein facilitate task execution by task executors, and validate results provided by those task executors on behalf of a task issuer. Such an approach enables a crowd-sourced approach to completion of drone-related tasks.

A task issuer (e.g., an entity desiring a task to be performed) submits a request for a task to be performed to a task execution facilitation system. A task definition included in the request includes information concerning the task that is to be performed (e.g., geographic boundaries of a region to be photographed, whether a map and/or model is required, desired qualities of the photographs, a reward that is to be provided upon completion of the task, etc.) In some examples, the task requests aerial images within boundaries of certain global positioning system (GPS) coordinates. Another task might request a three-dimensional (3D) model of a building at certain GPS coordinates. Another task might request updated aerial images on a weekly basis of a crop field to enable analysis of the growth.

The example task execution facilitation system enables a task executor (e.g., a drone operator and/or drone) to search for tasks that they are capable of and/or interested in completing. In response to a selection by the task executor, the task execution facilitation system allocates the selected task to the task executor. The example task executor performs the requested task and supplies the task execution facilitation system with the results (e.g., images, a map, a model, etc.). In some examples, the task execution facilitation system processes the results provided by the task executor to, for example, generate a map, generate a model, perform image processing (e.g., cleanup), etc. The example task execution facilitation system validates the results based on the task definition provided by the task issuer. If the results are valid, the results are provided to the task issuer, and a reward (as defined by the task issuer) is issued to the task executor.

In some examples, the reward is a financial compensation. However, other approaches for issuing a reward are available as well. For example, the task execution facilitation system may maintain issue non-financial compensation (e.g., awards, medals, achievements, etc.) to the task executors (e.g., users) based on the tasks that the task executor has completed. In such an example, the task executor may be awarded achievements, medals, etc. indicating what that user has completed such as, for example, how many square miles of area they have mapped (e.g., “ten square miles mapped”), how many tasks have been completed, how quickly the tasks have been completed (e.g., “completed 5 tasks within three days of their creation”), etc. In some examples, the task issuer provides a rating of the results indicating a quality of the results and/or their experience with interacting with the task executor. In some examples, such an approach motivates task executors to execute tasks even if the financial compensation is not as great as hoped for.

In some examples, a task issuer may also change the reward based on, for example, the quality of the results. The task issuer may, for example, provide a first reward (e.g., $500) for low to medium quality results, and provide a second reward greater than the first reward (e.g., $1000) for high-quality results. If, for example, the results and/or images originate from a cheaper consumer drone, the quality might not be as high as if a professional drone were used (e.g., a drone using a camera capable of using quick shutter speeds). In some examples, the task execution facilitation system rates the results to determine a level of quality of the results by, for example, detecting a sharpness of the images, level of sharpness, detecting a number of edges in the images, detecting noise levels in the images, etc.

In some examples, third party entities such as mapping services (e.g., Google Maps, Google Earth, Bing Maps, etc.) are interested the results of the mapping and/or modeling operations. Results may, in some examples, be provided to the third party entities to facilitate updating their maps and/or models. In some examples, third party entities may provide a portion of the reward issued to the task executor in return for being provided with the results. For example, a third party mapping service may provide 20% of the reward to be granted access to the results (e.g., maps, images, models, etc.).

Data validity is a key concern in such a system. Task executors may, for example, attempt to provide publicly available images (e.g., images previously provided by a third party mapping service) as their result. To avoid cheating (e.g., submitting old or invalid data), example task execution facilitation systems disclosed herein perform a validity check against the results provided by the task executor. For example, captured data is compared with existing mapping services (e.g., Google Maps, Here Maps, Bing Maps, etc.), and if a similarity score is above a threshold (e.g., the provided images match the publicly available images with greater than 99% accuracy), the results may be rejected as having been copied from the publicly available images. Even when capturing images of the same objective, it is expected that images will be taken from different locations and/or vantage points, and/or that environmental and/or lighting conditions will result in a similarity less than the threshold. In contrast, if the similarity is too low, this could indicate that the task executor did not capture images of the correct objective. In some examples, the task issuer is given the option to accept or reject results that are too similar and/or too dissimilar to prior images of the objective. In some examples, the task issuer provides a rating concerning the results provided by the task executor. Such ratings help to build credibility for frequent pilots who use the platform. In some examples, task executors may not be allocated tasks for which their results cannot be validated (e.g., tasks where existing results are not available for comparison).

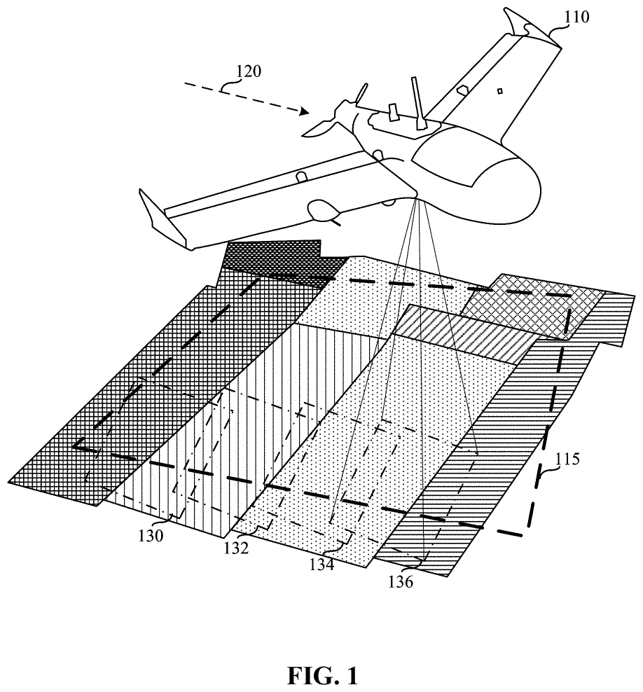

FIG. 1 is a diagram of an example drone 110 capturing images of a region 115 for the creation of a two-dimensional map. In the illustrated example of FIG. 1, the drone 110 travels along a path 120 and uses a camera to capture images 130, 132, 134, 136 of the region 115. In the illustrated example of FIG. 1, the region 115 is a large area that cannot be captured in a single image using a drone. As a result, multiple images (e.g., images 130, 132, 134, 136) are captured and later processed to create a single two-dimensional map. As used herein, a map is a two-dimensional representation of a region and may be generated based on one or more images. In some examples, multiple two-dimensional maps may be created. In some examples, the multiple images are later processed to create a three-dimensional model of the region 115. Creating a three-dimensional model may be beneficial because, for example, the three-dimensional model may enable identification of a height of a crop in a field, may enable terrain surveying, etc.

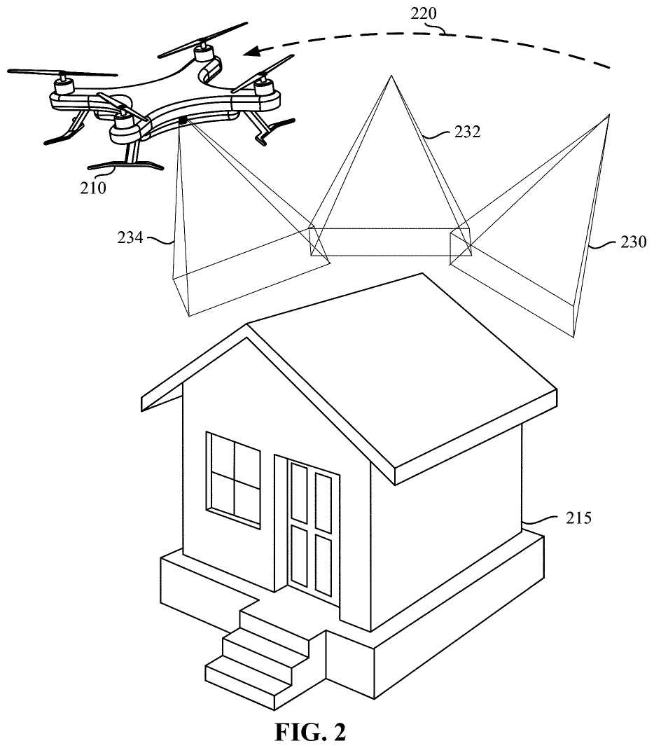

FIG. 2 is a diagram of an example drone 210 capturing images of a structure 215 for the creation of a three-dimensional model. In the illustrated example of FIG. 2, the example drone 210 travels along a path 220 and uses a camera to capture images 230, 232, 234 of the structure 215. In the illustrated example of FIG. 2, the structure 215 is a three-dimensional object that cannot be fully captured in a single two-dimensional image. As a result, multiple images (e.g., images 230, 232, 234) are captured and are later processed to create a three-dimensional model. In the illustrated example of FIG. 2, three images 230, 232, 234 are shown. However, in practice, additional images may be acquired to better enable generation of a three-dimensional model. For example, thirty images, fifty images, one hundred images, etc. may be captured. In some examples, the model depicts three-dimensional surfaces of the structure 215. In some examples, the surfaces of the three-dimensional model are textured using portions of the captured images. Creating a three-dimensional model of a structure may be beneficial because, for example, it may enable detection of whether a portion of the structure has been damaged.

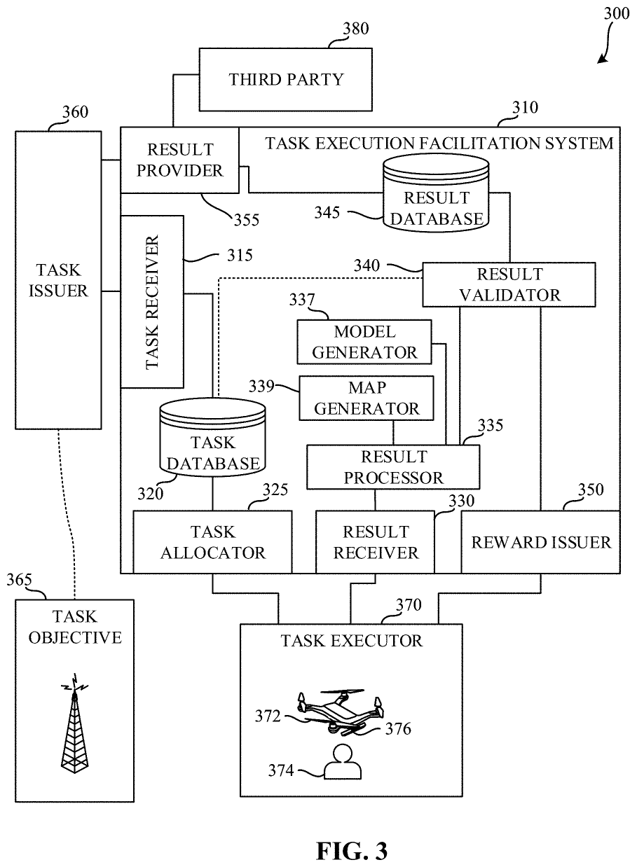

FIG. 3 is a block diagram of an example environment of use 300 including a task execution facilitation system 310. The example task execution facilitation system 310 of the illustrated example of FIG. 3 includes a task receiver 315, a task database 320, a task allocator 325, a result receiver 330, result processor 335, a model generator 337, a map generator 339, a result validator 340, a result database 345, a reward issuer 350, and a result provider 355. In the example environment of use 300 of the illustrated example of FIG. 3, the example task execution facilitation system 310 is provided a task definition by a task issuer 360. The task definition identifies a task that is to be performed concerning the example task objective 365. The example task executor 370 communicates with the example task execution facilitation system 310 to select a task to be performed. The example task executor 370 performs the task and provides a result of the performance of the task to the example task execution facilitation system 310. The example task execution facilitation system 310 processes and/or validates the results provided by the task executor 370 and provides those results to the task issuer 360. In some examples, the task execution facilitation system 310 provides those results to a third-party 380. The example task execution facilitation system 310 communicates with the example task issuer 360, the example task executor 370, and the example third party 380 via networks 390, 391, 392.

The example task receiver 315 of the illustrated example of FIG. 3 is implemented by a web interface (e.g., website) that enables the task issuer 360 to provide their task definition to the example task execution facilitation system 310. In some examples, the task receiver 315 enables the task issuer 360 to identify and/or retrieve a status of their tasks that have been submitted to the task execution facilitation system. For example, upon allocation of the task by the task allocator 325 (and/or recordation of such allocation in the task database 320) the example task issuer 360 may be able to view status information concerning completion of those tasks (e.g., has the task been allocated to a task executor). In examples disclosed herein, the example task receiver 315 stores the task definition in the example task database 320.

As used herein, a task definition defines properties and/or criteria of a task that is to be performed by task executor. Such criteria may include, for example, geographic parameters of where the task is to be performed, time and/or date parameters specifying when the task is to be performed, quality parameters specifying quality thresholds concerning the execution of the task (e.g., acceptable levels of blur, required image resolution, etc.), whether the task results are to include a map and/or a model, rewards that would be issued in response to performance of the task, rules for issuing rewards (e.g., based on quality of the results and/or whether any other task executors have previously performed and/or simultaneously performed the task), whether multiple task executor should be allowed to perform the task at the same time (e.g., a maximum number of task executors to whom the task can be allocated), features that are to be required in the results, whether the results may be provided to the third-party 380, etc.

The example task database 320 the illustrated example of FIG. 3 is implemented by any memory, storage device and/or storage disc for storing data such as, for example, flash memory, magnetic media, optical media, etc. Furthermore, the data stored in the example task database 320 may be in any data format such as, for example, binary data, comma delimited data, tab delimited data, structured query language (SQL) structures, etc. While in the illustrated example the task database 320 is illustrated as a single element, the example task database 320 and/or any other data storage elements described herein may be implemented by any number and/or type(s) of memories. In the illustrated example of FIG. 3, the example task database 320 stores task definitions as provided by the example task issuer 360. In some examples, the example task database 320 stores record(s) identifying task executor(s) to whom each task has been allocated. In some examples, the example task database 320 stores information concerning whether a given task has been completed.

The example task allocator 325 of the illustrated example of FIG. 3 is implemented by a web interface (e.g., a website) that enables the example task executor 370 to provide search parameters to the task allocator 325. The example task allocator 325 using the provided search parameters searches the example task database 320 to identify tasks that meet the provided search parameters. Those search results are then provided to the example task executor 370 in the form of a webpage. However, any other approach to providing search results may additionally or alternatively be used. In some examples, the task executor 370 selects a task (e.g., a task provided in the search results), for execution and provides an indication of such selection to the task allocator 325. The example task allocator 325 then allocates the selected task to the task executor 370. To allocate the task to the task executor 370, the example task allocator 325 stores a record in the task database.

In some examples, the task issuer 360 may specify that the task can be allocated to multiple task executors. In some examples, the task issuer 360 defines a maximum number of task executors to whom the task can be allocated. Defining a maximum number of task executors to whom the task can be allocated ensures that results will not be provided by more than the maximum number of task executors. In such an example, prior to allocation of the task, the task allocator 325 may determine whether the maximum number of allocations has been met, and if such number of allocations has been met, the task allocator 325 does not allocate the task to the task executor 370. When results are provided by multiple task executors, it is possible that the task issuer 360 may need to provide rewards (e.g., a financial compensation) to multiple task executors. Defining a maximum number of potential task executors sets a corresponding maximum financial compensation that may be required of the task issuer 360.

The example result receiver 330 of the illustrated example of FIG. 3 is implemented by a web interface (e.g., a website) that enables the example task executor 370 to provide results of the execution of the task to the example task execution facilitation system 310. In examples disclosed herein, the results are provided by uploading them to the result receiver 330. However, any other approach to providing results to the result receiver 330 may additionally or alternatively be used. For example, the drone 372 and/or the camera 376 may automatically upload results to the result receiver 330. The example result receiver 330 provides the received results to the result processor 335.

The example result processor 335 of the illustrated example of FIG. 3 processes the results received via the result receiver 330. In some examples, the example result processor 335 performs image processing on the received images to prepare such images for use by the example model generator 337 and/or the example map generator 339. In examples disclosed herein, the result processor 335 determines whether the task definition with which the results are associated requires a model and/or a map to be included in the results. If the task definition requires a model and/or a map, but no model and/or map was received, the example result processor 335 interfaces with the example model generator 337 and/or the example map generator 339 corresponding to the requirements of the task definition to generate the model and/or map.

The example model generator 337 of the illustrated example of FIG. 3 receives images that are included in the results provided by the task executor 370 from the result processor 335. In some examples, the result processor 335 is preprocessed those images to facilitate generation of the model by the example model generator 337. In response to receipt of the images, the example model generator 337 generates a model of the task objective 365. In examples disclosed herein, the example model generator 337 uses photogrammetry techniques to generate the model. However, any other technique for generating a model may additionally or alternatively be used. In examples disclosed herein, the model is a three-dimensional model that is textured using the supplied images. However, any other type of model may additionally or alternatively be used.

In the illustrated example of FIG. 3, the example model generator 337 is illustrated as a component of the example task execution facilitation system 310. However, in some examples, the example model generator 337 may be implemented externally to the task execution facilitation system 310. In such an example, the model generator 337 may be implemented by a cloud-based photogrammetry service.

The example map generator 339 of the illustrated example of FIG. 3 receives images that are included in the results provided by the task executor 370 from the result processor 335. In some examples, the result processor 335 has preprocessed those images to facilitate generation of the map by the example map generator 339. In response to receipt of the images, the example map generator 339 generates a map of the task objective 365. In examples disclosed herein, the example map generator 339 uses photo stitching techniques to generate the map. However, any other technique for generating a map may additionally or alternatively be used.

In the illustrated example of FIG. 3, the example map generator 339 is illustrated as a component of the example task execution facilitation system 310. However, in some examples, the example map generator 339 may be implemented externally to the task execution facilitation system 310. In such an example, the map generator 339 may be implemented by a cloud-based mapping service.

The example result validator 340 the illustrated example of FIG. 3 validates the results provided by the task executor 370 and/or is generated and processed by the result processor 335. In examples disclosed herein, the result validator 340 validates the results by comparing images included in the results to known images of the task objective 365. In examples disclosed herein, the example result validator 340 acquires known images of the task objective 365 from the third-party 380. That is, the known images are acquired from publicly available mapping services and/or other sources for images of the task objective 365. In some examples, the task issuer 360 provides images of the task objective 365 for use by the example result validator 340. In some examples, the known images correspond to previous executions of the task and/or other tasks concerning the same task objective 365. The example result validator 340 determines a similarity score of the provided results to the known results. In examples disclosed herein, the result validator 340 determines the similarity based on color histograms of the provided images against the known images of the task objective. However, any other past, present, and/or future approach to determining a level of similarity between images may additionally or alternatively be used.

The example result validator 340 compares the similarity score to threshold similarities to validate the results. A first threshold similarity is used to detect a high degree of similarity between the results and prior known images of the task objective. In examples disclosed herein, the first threshold is 99%. However, any other threshold value may additionally or alternatively be used. In examples disclosed herein, using the high threshold (e.g., greater than 99% image similarity) is used to detect when the task executor 370, instead of properly performing the task, has copied images from a publicly available site and/or source (e.g., from the third-party 380) and supplied those images as their own results. If the example result validator 340 determines that the similarity score exceeds the first threshold similarity (e.g., the similarity score suggests that the task executor has copied images), the example result validator 340 identifies the results as invalid.

In some examples, the example result validator 340 determines whether the similarity score is below a second threshold similarity. In examples disclosed herein, the second threshold similarity is a low threshold similarity such as, for example, 1%. Performing a check to determine whether the supplied results have a threshold similarity to known images enables the result validator to detect when the task executor 370 has provided results that do not match what would have been expected of the task objective 365. Such an approach ensures that the task execution facilitation system 310 rejects results that are not properly taken of the task objective. Thus, if the example result validator 340 determines that the similarity score is below the second threshold similarity, the example result validator identifies the results as invalid.

The example result validator 340 determines one or more quality metrics of the provided results. In examples disclosed herein, the quality of the results is a number of edges detected in the provided images. However, any other approach to determining a quality of the provided results may additionally or alternatively be used such as, for example, a number of vertices in a three-dimensional model, a quantification of blur in the provided images, a resolution of the provided images, etc. The example result validator 340 compares the determined quality of the provided results to specify quality thresholds provided in the task definition supplied by the example task issuer 360. In some examples, the quality thresholds are not provided by the task issuer 360 and instead are quality thresholds that are applied to any task (e.g., default quality thresholds). If the quality of the provided results does not meet the specified quality threshold, the example result validator 340 identifies the results as invalid.

In some examples, the tax definition indicates that a map and/or a model is to be provided. The example result validator 340 determines whether the provided and/or generated model and/or map include features set forth in the task definition. In some examples, the task issuer 360 may provide one or more listings and identifications of features that are expected to be provided in the map and/or model. For example, if the task objective is a cellular tower, the example task issuer 360 may indicate that the results must indicate include a wireless antenna and/or a shape/object that resembles a wireless antenna. If the model and/or map does not include such a feature, the example result validator 340 identifies the results as invalid.

The example result validator 340 determines whether metadata provided in the results satisfies the task definition. In some examples, the task definition may specify particular characteristics of the images that are to be adhered to for those images to be valid. For example, the task definition may specify a time of day that the images are to be captured. If the metadata supplied as part of and/or in connection with the images included in the results does not adhere to the time of day restrictions set forth in the task definition, such results may be identified as invalid as not complying with the task definition. Moreover, any other property of the images and/or model may additionally or alternatively be used to facilitate validation such as, for example, a shutter speed of a camera, a geographic location at the time of capture of an image, etc. If the metadata does not adhere to the restrictions set forth in the task definition (e.g., block 980 returns a result of NO), the example result validator 340 identifies the results as invalid.

If the example result validator 340 does not detect any validation errors, the results are identified as valid and are stored in the result database 345. Validating the results using the example result validator 340 provides assurances to task executors that provide their results to the task execution facilitation system 310 that their results will not be arbitrarily judged by a task issuer 360 to determine whether they will receive a reward. Similarly, the task issuers 360 are assured that they will not be provided results that do not meet the quality standards and/or requirements of their task.

The example result database 345 of the illustrated example of FIG. 3 is implemented by any memory, storage device and/or storage disc for storing data such as, for example, flash memory, magnetic media, optical media, etc. Furthermore, the data stored in the example result database 345 may be in any data format such as, for example, binary data, comma delimited data, tab delimited data, structured query language (SQL) structures, etc. While in the illustrated example the result database 345 is illustrated as a single element, the example result database 345 and/or any other data storage elements described herein may be implemented by any number and/or type(s) of memories. In the illustrated example of FIG. 3, the example result database 345 stores results that have been validated by the example result validator 340. In some examples, the results are stored in the example result database 345 upon receipt from the task executor 370.

The example reward issuer 350 of the illustrated example of FIG. 3 executes a transaction between the task issuer 360 and the task executor 370 to issue an award to the task executor 370. In examples disclosed herein, the transaction between the task issuer 360 and the task executor 370 is a financial transaction in which the task executor 370 is financially compensated for the performance of the task. In some examples, the transaction additionally involves the third-party 380. For example, the third-party 380 may supply a portion (e.g., 20%) of the financial compensation to the task executor 370 in return for the results of the task being provided to the third-party 380.

In some examples, the reward issued to the task executor 370 is not a financial reward. For example, the reward issuer 350 may issue an achievement and/or a medal to the task executor based on the task performed and/or prior tasks that have been performed by the task executor 370. For example, the reward may indicate an achievement that the task executor 370 has made such as, for example, having photographed a threshold area of land (e.g., ten acres), having completed a threshold number of tasks (e.g., ten tasks completed), having completed a number of tasks in a given amount of time (e.g., five tasks completed in under two days), having provided a threshold quality of results (e.g., images of a threshold resolution, images having a low amount of blur, a model having a threshold number of vertices, etc.), etc.

The example result provider 355 of the illustrated example of FIG. 3 is implemented by a web interface (e.g., a website) through which the example task issuer 360 may access results stored in the example result database 345. In some examples, the example third-party 380 is also granted access to the results in the result database 345. Access to the results in the result database 345 through the result provider 355 by the third-party 380 is controlled by the task definition provided by the task issuer 360 (e.g., has the task issuer 360 allowed sharing of the results with the third party 380?). In examples disclosed herein, the example result provider 355 alerts the task issuer 360 of the presence of the validated results stored in the result database by transmitting a message (e.g., an email message) to the task issuer 360. However, any other past, present, and/or future approach to alerting the task issuer 360 to the presence of results in the example result database 345 may additionally or alternatively be used.

The example task issuer 360 of the illustrated example of FIG. 3 is an entity that desires a task to be performed. For example, the task issuer 360 may be a realtor who would like to have a property photographed, map, and/or modeled for listing purposes, the example task issuer 360 may be a farmer who wishes to have their farm imaged, mapped, and/or modeled to better understand crop growth etc.

The example task issuer 360 submits a request for a task to be performed to the example task execution facilitation system 310. In the illustrated example of FIG. 3, the example task issuer 360 provides a task definition to the example task receiver 315. In the illustrated example of FIG. 3, a single task issuer 360 is shown. However, in practice, it is expected that many task issuers will exist to provide task definitions. As noted above, the example task definition defines properties and/or parameters within which the task is to be executed. Upon completion of the task and validation of the results by the example result validator 340, the results are provided to the example task issuer 360 by the example result provider 355. The example reward issuer 350 executes the transaction intermediate the task issuer 360 and the task executor 370 such that the task issuer 360 provides a reward to the task executor 370 for the performance of the task.

In examples disclosed herein, the task issuer 360 is not involved in validation of the results. Thus, the task executor 370 can expect that their results will be validated only against those parameters defined in the task definition (e.g., will not be validated arbitrarily). However, in some examples, the example task issuer 360 may be involved in validation of the results. For example, when the example result validator 340 is not able to identify any known images of the example task objective 365, it may not be possible for the result validator 340 to perform a complete validation of the results provided by the task executor 370. In such cases, the example task issuer 360 may confirm or reject the results.

The example task objective 365 of the illustrated example of FIG. 3 is a structure and/or a region that is to be photographed by the task executor 370. In the illustrated example of FIG. 3, the example task objective 365 is a cellular tower operated by a wireless service provider. The example wireless service provider may wish to have a task executor (e.g., the task executor 370) periodically survey the cellular tower to confirm that there has been no damage. The results of such surveying (e.g., the images of the cellular tower, a map of the region surrounding the cellular tower, and/or a model of the cellular tower itself) may be useful in validating there has been no damage to the cellular tower. However, any other task objective (e.g., structure and/or region) may additionally or alternatively be used. For example, the task objective 365 may be a farm (e.g., a plot of land that is to be periodically monitored for crop growth), the example task objective may be a home that an insurance adjuster wishes to have surveyed before approving an insurance claim, etc.

The example task executor 370 of the illustrated example of FIG. 3 searches for tasks using the example task allocator 325, executes the selected task(s), and provides results of the execution of those tasks to the example result receiver 330. In the illustrated example of FIG. 3, a single task executor 370 is shown. However, in practice, it is expected that many task executors will exist for performance of the tasks defined by the task issuers. In the illustrated example of FIG. 3, the example task executor includes a drone 372 operated by an operator 374. In the illustrated example of FIG. 3, the drone includes a camera 376 that captures images of the task objective. In the illustrated example of FIG. 3, the drone is a quadrocopter. However, any other type of drone may additionally or alternatively be used such as, for example, a fixed wing aircraft, a helicopter-style drone, etc. In the illustrated example of FIG. 3, the drone 372 includes a single camera 376. However, in some examples, multiple cameras may additionally or alternatively be used. In some examples, multiple cameras of different types and/or having different specifications (e.g., different lenses) are used.

The example third party 380 of the illustrated example of FIG. 3 is a third-party entity that is separate from the example task issuer 360 and/or the example task executor 370. In examples disclosed herein, the example third-party 380 is a third-party mapping service that provides maps and/or models to the public. For example, the third-party 380 may be implemented by Google maps, Bing maps, Here maps, etc. in some examples, the third-party 380 is given access to results of completed tasks in the example result database 345. Having access to such results enables the third-party 380 to update their maps to use the most up-to-date images, maps, and/or models. In return for access to such results, in some examples, the third-party 380 supplies a portion of the reward issued to the task executor 370. In some examples, the example third-party 380 provides known images of task objectives (e.g., the task objective 365) to enable the result validator 340 to determine if the task executor 370 has properly performed the task.

The example networks 390, 391, 392 of the illustrated example of FIG. 3 is implemented by the Internet. However, any other network(s) may additionally or alternatively be used. For example, the network(s) 390, 391, 392 may be implemented by one or more private networks, virtual private networks (VPNs), public networks, etc. While in the illustrated example of FIG. 3, three separate networks are shown, such networks may be implemented by a single network.

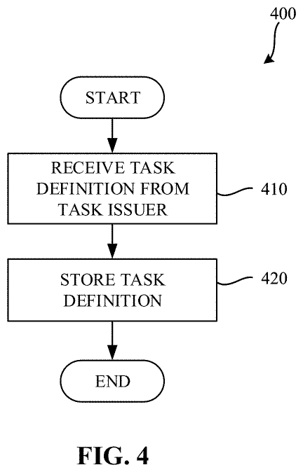

While an example manner of implementing the task execution facilitation system 310 is illustrated in FIG. 3, one or more of the elements, processes and/or devices illustrated in FIG. 3 may be combined, divided, re-arranged, omitted, eliminated and/or implemented in any other way. Further, the example task receiver 315, the example test database 320, the example task allocator 325, the example result receiver 330, the example result processor 335, the example model generator 337, the example map generator 339, the example result validator 340, the example result database 345, the example reward issuer 350, the example result provider 355, and/or, more generally, the example task execution facilitation system 310 of FIG. 3 may be implemented by hardware, software, firmware and/or any combination of hardware, software and/or firmware. Thus, for example, any of the example task receiver 315, the example test database 320, the example task allocator 325, the example result receiver 330, the example result processor 335, the example model generator 337, the example map generator 339, the example result validator 340, the example result database 345, the example reward issuer 350, the example result provider 355, and/or, more generally, the example task execution facilitation system 310 of FIG. 3 could be implemented by one or more analog or digital circuit(s), logic circuits, programmable processor(s), application specific integrated circuit(s) (ASIC(s), programmable logic device(s) (PLD(s) and/or field programmable logic device(s) (FPLD(s). When reading any of the apparatus or system claims of this patent to cover a purely software and/or firmware implementation, at least one of the example task receiver 315, the example test database 320, the example task allocator 325, the example result receiver 330, the example result processor 335, the example model generator 337, the example map generator 339, the example result validator 340, the example result database 345, the example reward issuer 350, the example result provider 355, and/or, more generally, the example task execution facilitation system 310 of FIG. 3 is/are hereby expressly defined to include a non-transitory computer readable storage device or storage disk such as a memory, a digital versatile disk (DVD), a compact disk (CD), a Blu-ray disk, etc. including the software and/or firmware. Further still, the example task execution facilitation system 310 of FIG. 3 may include one or more elements, processes and/or devices in addition to, or instead of, those illustrated in FIG. 4, and/or may include more than one of any or all of the illustrated elements, processes, and devices.

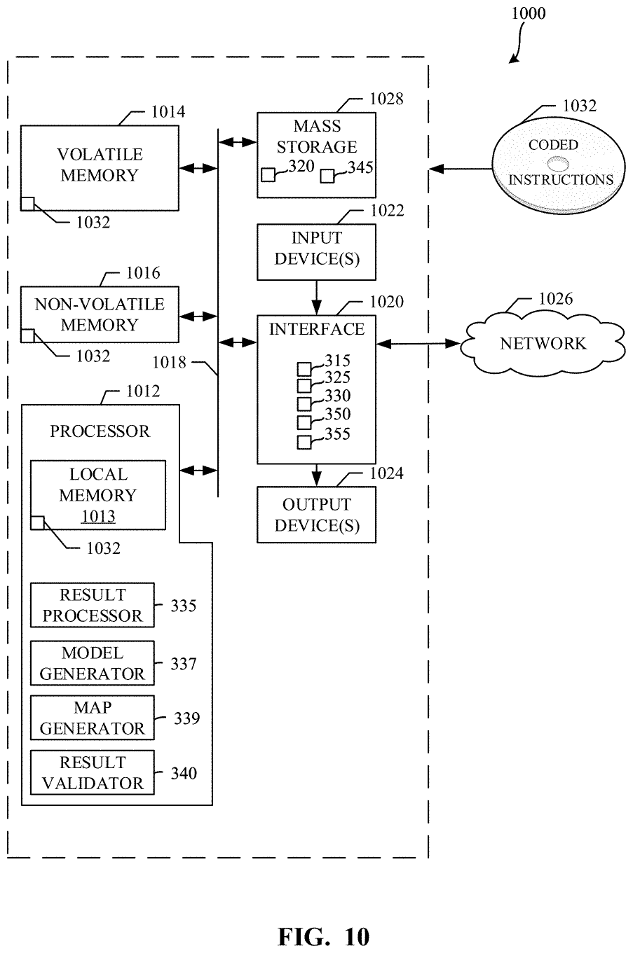

Flowcharts representative of example machine readable instructions for implementing the example task execution facilitation system 310 FIG. 3 are shown in FIGS. 4, 5, 8, and/or 9. In these examples, the machine readable instructions comprise a program for execution by a processor such as the processor 1012 shown in the example processor platform 1000 discussed below in connection with FIG. 10. The program may be embodied in software stored on a non-transitory computer readable storage medium such as a CD-ROM, a floppy disk, a hard drive, a digital versatile disk (DVD), a Blu-ray disk, or a memory associated with the processor 1012, but the entire program and/or parts thereof could alternatively be executed by a device other than the processor 1012 and/or embodied in firmware or dedicated hardware. Further, although the example program is described with reference to the flowchart(s) illustrated in FIGS. 4, 5, 8, and/or 9, many other methods of implementing the example task execution facilitation system 310 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, a Field Programmable Gate Array (FPGA), an Application Specific Integrated circuit (ASIC), a comparator, an operational-amplifier (op-amp), a logic circuit, etc.) structured to perform the corresponding operation without executing software or firmware.

As mentioned above, the example processes of FIGS. 4, 5, 8, and/or 9 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. “Including” and “comprising” (and all forms and tenses thereof) are used herein to be open ended terms. Thus, whenever a claim lists anything following any form of “include” or “comprise” (e.g., comprises, includes, comprising, including, etc.), it is to be understood that additional elements, terms, etc. may be present without falling outside the scope of the corresponding claim. As used herein, when the phrase “at least” is used as the transition term in a preamble of a claim, it is open-ended in the same manner as the term “comprising” and “including” are open ended.

FIG. 4 is a flowchart representative of example machine-readable instructions 400 which may be executed to implement the example task execution facilitation system 310 of FIG. 3 to receive a task definition from a task issuer 360. The example process 400 of the illustrated example of FIG. 4 begins when the example task receiver 315 receives a task definition from the task issuer 360. (Block 410). In examples disclosed herein, the task receiver 315 is received as a submission to a webpage. However, any other approach to receiving a task definition from the task issuer 360 may additionally or alternatively be used. The example task receiver 315 stores the task definition in the example task database 320. (Block 420).

In some examples, the example task receiver 315 validates the received task definition to, for example, ensure that the task definition specifies a task that can actually be completed. For example, the task receiver 315 may validate the task definition to confirm that geographic coordinates have been provided, to confirm that the requested time of performance of the task is not in the past, to confirm that the geographic coordinates provided in the task definition would not cause the task executor 370 to enter restricted airspace and/or a no-fly zone, etc.

Once the example task definition is stored in the task database 320, the example task allocator 325 may search among the task definitions to enable a task executor 370 to select the task to be performed.

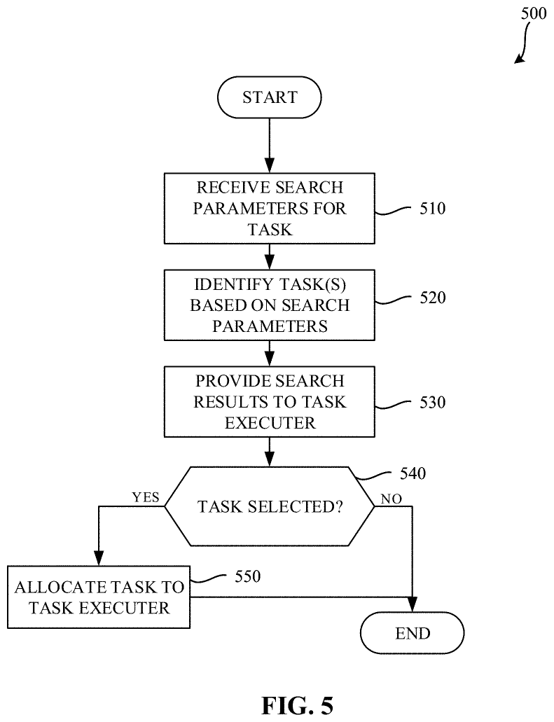

FIG. 5 is a flowchart representative of example machine-readable instructions 500 which may be executed to implement the example task execution facilitation system 310 of FIG. 3 to allocate a task to a task executor 370. The example process 500 of the illustrated example of FIG. 4 begins when the example task allocator 325 receives a search parameter from the task executor 370. (Block 510). In examples disclosed herein, the search parameters identify one or more characteristics of a task that the task executor is searching for (e.g., would be willing to perform). For example, the search parameters may include a geographic region in which the task executor 370 is going to operate, a time of day at which the task executor is willing to perform the task, an indication of the expected results (e.g., whether a map and/or a model are to be included), quality metrics that are to be adhered to, etc.

In some examples, the search parameters may be associated with the task executor 370 and/or, more specifically, the drone 372 or the camera 376. For example, a resolution at which the camera 376 is capable of taking images may be used as a search parameter when searching for tasks. Using the received search parameters, the example task allocator 325 searches the example task database 320 to identify tasks that meet the search parameters. (Block 520). The example task allocator 325 provides the search results to the task executor 370. (Block 530). In examples disclosed herein, the search results are provided to the task executor 370 in the form of webpage. However, any other approach to providing search results may additionally or alternatively be used. The search results may then be reviewed by the example task executor 370.

In some examples, the task executor 370 may select a task performance and inform the example task allocator 325 of their selection. The example task allocator 325 determines whether a task has been selected. (Block 540). If no task has been selected (e.g., Block 540 returns a result of NO), the example process 500 of the illustrated example of FIG. 5 terminates. If the example task allocator 325 determines that a task has been selected (e.g., Block 540 returns a result of YES), the example task allocator allocates the task to the task executor 370. (Block 550). When allocating the selected task to the task executor 370, the example task allocator 325 records such allocation in the example task database 320. Recording the allocation of the task in the task database 320 enables the task issuer 360 to be informed of whether a task executor 370 has selected their task for execution.

In some examples, the task issuer 360 may define that the task can be allocated to multiple task executors. In some examples, the task issuer 360 defines a maximum number of task executors to whom the task can be allocated. Defining a maximum number of task executors to whom the task can be allocated ensures that results may not be provided by more than the maximum number of task executors. In such an example, prior to allocation of the task, the task allocator 325 may determine whether the maximum number of allocations has been met, and if such number of allocations has been met, the task is not allocated to the task executor 370. When results are provided by multiple task executors, it is possible that the task issuer 360 may need to provide rewards (e.g., a financial compensation) to multiple task executors. Defining a maximum number of potential task executors sets a corresponding maximum financial compensation that may be required of the task issuer 360. In some examples, the example task allocator sets an expiration timer that enables the task to be allocated to the task executor for a period of time. In examples disclosed herein, the timer may be set to five days. However, any other timer duration may additionally or alternatively be used. If, for example, the timer expires and the task has not yet been completed by the task executor 380, the allocation of the task may be removed such that another task executor 380 may be allocated the task. Upon allocation of the task, the example process 500 the illustrated example of FIG. 5 terminates.

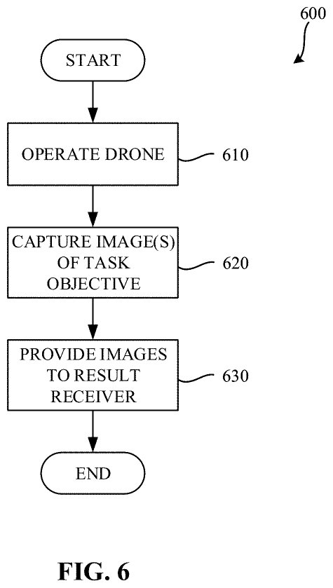

FIG. 6 is a flowchart representative of example machine-readable instructions which may be executed to implement the example task executor 370 of FIG. 3 to provide a result of a completed task to the example task execution facilitation system 310 of FIG. 3. The example process 600 of the illustrated example of FIG. 6 represents a scenario where the example task executor 370 captures images of the task objective 365 and submits those images to the task execution facilitation system 310 without processing those images on their own to create a map and/or model. In such a scenario, the example task execution facilitation system 310 may process the images, if required by the task definition, to generate a map and/or model in accordance with the task definition.

The example process 600 the illustrated example of FIG. 6 begins when the example operator 374 operates the drone to move about the task objective 365. (Block 610). While moving about the task objective 365, the example camera 376 attached to the drone 372 captures images of the task objective 365. (Block 620). In examples disclosed herein, the images are stored in a memory of the drone 372 and/or of the camera 376. The example task executor 370 then provides the captured images to the result receiver 330. (Block 630). In examples disclosed herein, the images are provided to the result receiver 330 by submission via a webpage. However, any other approach to providing images to a result receiver 330 may additionally or alternatively be used. In examples disclosed herein, the example operator 374 submits the images via a computing device (e.g., a personal computer, a mobile device, a laptop, a tablet, etc.). However, in some examples, the images may be automatically uploaded to the result receiver 330 from the drone 372 and/or the camera 376.

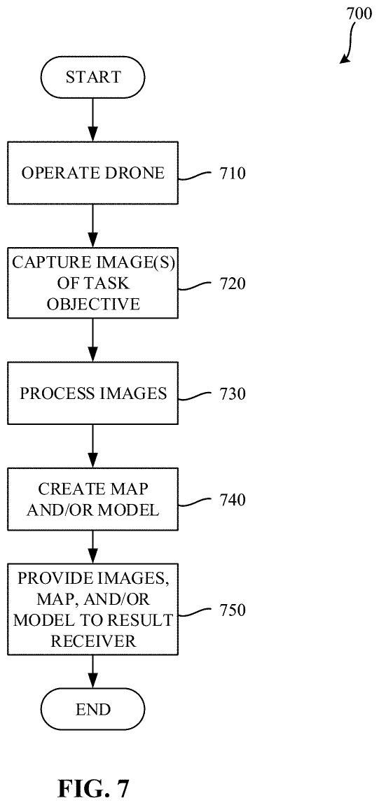

FIG. 7 is a flowchart representative of example machine-readable instructions which may be executed to implement the example task executor 370 of FIG. 3 to provide a result of a completed task to the example task execution facilitation system 310 of FIG. 3. The example process 700 of the illustrated example of FIG. 7 represents a scenario where the example task executor 370 captures images of the task objective 365, processes the captured images to create a map and/or model, and supplies the images, the map, and/or the model to the result receiver 330.

The example process 700 the illustrated example of FIG. 7 begins when the example operator 374 operates the drone 372 to move about the task objective 365. (Block 710). While moving about the task objective 365, the example camera 376 attached to the drone 372 captures images of the task objective 365. (Block 720). In examples disclosed herein, the images are stored in a memory of the drone 372 and/or of the camera 376.

The example task executor 370 then processes those images using, for example, image processing software. (Block 730). In some examples, the processing may be performed to, for example, adjust brightness, adjust contrast, crop the images, etc. The example task executor 370 then generates a map and remodel in accordance with the task definition. (Block 740). In examples disclosed herein, the example task executor 370 may utilize any mapping and/or modeling techniques (e.g., a photogrammetry system) to generate the example map and/or model. In some examples, the task executor 370 may supply the images to a third-party mapping and/or modeling service for preparation of the map and/or model. The example task executor 370 then provides the images, the map, and/or the model to the result receiver 330. In examples disclosed herein, the images, the map, and/or the model are provided to the result receiver 330 by submission via a webpage. However, any other approach to providing the images, the map, and/or the model to the result receiver 330 may additionally or alternatively be used.

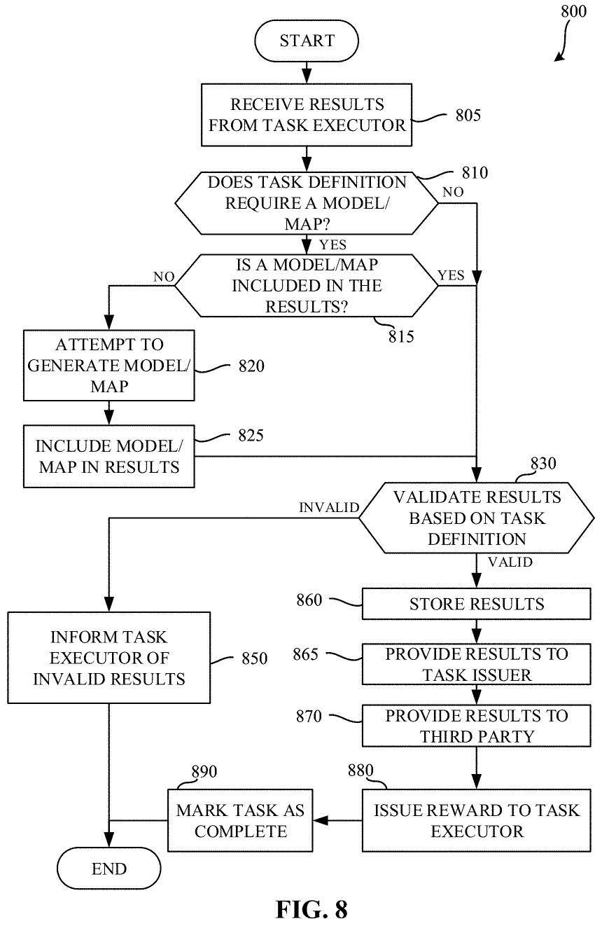

FIG. 8 is a flowchart representative of example machine-readable instructions 800 which may be executed to implement the example task execution facilitation system 310 of FIG. 3 to analyze the result of the task provided by the task executor 370. The example process 800 of the illustrated example of FIG. 8 begins when the example result receiver 330 receives results from the task executor 370. (Block 805). As discussed in connection with FIGS. 6 and/or 7, the example task executor 370 provides the results via a web interface. Moreover, in some examples, the results may include a map and remodel the may have been generated by the example task executor 370.

Upon receipt of the results, the example result processor 335 analyzes the task definition to which the results correspond to determine whether the task definition requires a map and/or model. (Block 810). If the task definition does not require a map and/or model (e.g., Block 810 returns result of NO), control proceeds to block 830 where the example result validator 340 validates the provided results based on the task definition. (Block 830).

If the task definition does require a map and/or model (e.g., Block 810 returns result of YES), the example result processor 335 determines whether the required map and/or model are provided in the results. (Block 815). If the map and/or the model included in the results (e.g., Block 815 returns a result of YES), control proceeds to block 830 where the example result validator 340 validates the provided results based on the task definition. (Block 830).

If the example result processor 335 determines that the task definition requires a map and/or model, and no such map or model is included in the results (e.g., Block 810 returns a result of YES and Block 815 returns a result of NO), the example result processor 335 interacts with the example model generator 337 and/or map generator 339 to attempt to generate the required map and/or model. (Block 820). In examples disclosed herein, the example result processor 335 coordinates with the example model generator 337 and/or the example map generator to generate the map and/or model based on the images supplied in the results. As noted above in connection with the illustrated example of FIG. 3, the example model generator 337 and/or the example map generator 339 may be implemented as an internal component of the task execution facilitation system 310, and/or may be provided by a third-party service (e.g., a cloud service) such as a third-party photogrammetry service, a third-party mapping service, etc. In some examples, prior to providing the images to the model generator 337 and/or the map generator 339, the example result processor 335 performs image processing (e.g., cleanup) on the images provided in the result. Such image processing may be used to, for example, reduce blur in the images, enhanced contrast, crop the images, etc. In some examples, preprocessing the images enhances the ability of the example model generator 337 and/or the example map generator 339 to construct accurate models and/or maps. The example result processor 335 receives the model and/or the map from the example model generator 337 and/or the example map generator 339, and includes the map and/or model in the results provided by the task executor 370. (Block 825). The results are then provided to the example result validator 340 for validation.

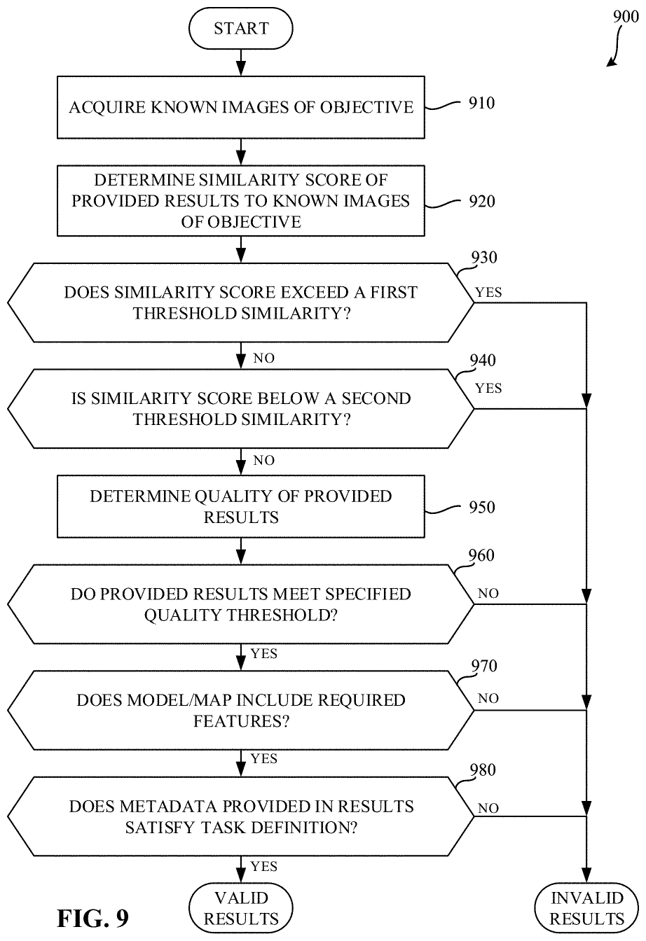

The example result validator 340 validates the results based on the corresponding task definition. (Block 830). An example approach for validating the results based on the task definition is disclosed below in connection with FIG. 9. In general, the example result validator 340 reviews the provided results and/or the map and/or model (that may have been generated by the example model generator 337 and/or map generator 339) to confirm that they comply with the task definition

If the example result validator 340 determines that the results are invalid (e.g., Block 830 returns a result of INVALID), the example result validator 340 informs the task executor 370 of the insufficient and/or invalid results via the example result receiver 330. (Block 850). In some examples, a message is transmitted to the example task executor to inform them of the validation failure. For example, an email message may be transmitted to the task executor 370. The example task executor 370 may then attempt to re-perform the task and/or modify the provided results to address the validation issues encountered by the example result validator 340. The example process 800 of the illustrated example of FIG. 8 then terminates. In some examples, if the model and/or map caused the validation error, the generation of the map and/or model may be re-attempted and those results re-validated before informing the task executor 370 of the invalid results.

If the example result validator 340 determines that the results are valid (e.g., Block 830 returns a result of VALID), the example result validator 340 stores the results in the result database 345. (Block 860). Storing the validated results in the example result database 345 enables the task issuer 360 and/or, in some examples, the third-party 380 to retrieve the results from the example result database 345. Upon successful validation of the results, the example result provider 355 provides the results to the task issuer 360. (Block 865). In examples disclosed herein, the result provider 355 provides the results to the example task issuer 360 by transmitting a message (e.g., an email message) to the example task issuer 360 informing the task issuer 360 of that the results are ready for retrieval in the example result database 345. However, any other past, present, and/or future approach to alerting the task issuer 360 of the results in a result database 345 and/or providing the results to the task issuer 360 may additionally or alternatively be used.

In the illustrated example of FIG. 8, the example result provider 355 provides the results to the third-party 380. In examples disclosed herein, the result provider 355 provides the results to the example third-party 380 by transmitting a message (e.g., an email message) to the example third-party 380 informing the third-party 380 that the results are ready for retrieval in the example result database 345. However, any other past, present, and/or future approach to alerting the third-party 380 of the results in a result database 345 and/or providing the results to the third-party 380 may additionally or alternatively be used. In some examples, the task issuer 360 may define (e.g., in the task definition), that the results are not to be made available to a third-party. In such examples, the providing of the results the third-party 380 (e.g., Block 870) is not performed.

If the example result validator 340 determines that the results are valid (e.g., Block 830 returns a result of VALID), the example reward issuer 350 executes the transaction between the task issuer 360 and the task executor 370 to issue an award to the task executor 370. (Block 880). In examples disclosed herein, the transaction between the task issuer 360 and the task executor 370 is a financial transaction in which the task executor 370 is financially compensated for the performance of the task. In some examples, the transaction additionally involves the third-party 380. For example, the third-party 380 may supply a portion (e.g., 20%) of the financial compensation to the task executor 370 in return for the results of the task being provided to the third-party 380.

In some examples, multiple task executors may have been involved in the performance of the task for the task issuer 360. In such examples, the example reward issuer 350 determines amounts of compensation that are to be given to the task executor 370 based on, for example, the task definition provided by the task issuer 360. For example, the task issuer 360 may define that when multiple task executors perform the same task, a first reward is to be issued to the first task executor to complete the task, and a second reward (e.g., a smaller financial compensation) is to be issued to the second and/or subsequent task executor to complete the task. In some examples, the reward may be based on the quality of the results provided. For example, if the results are deemed to be of high quality (e.g., as quantified by the result validator 340), a larger reward may be issued than had the result validator 340 identified the results to be of low quality.

In the illustrated example of FIG. 8, the reward is issued to the task executor 370 without the involvement of the task issuer 360 approving the result. Such an approach ensures that task executors will trust that the reward will be issued once the task is completed (assuming those results comply with the task definition), and also ensures that the task issuer 360 provides complete task definitions for the performance of their task. Such an approach also removes ambiguity in what was requested by the task issuer 360, and ensures that the results will not be arbitrarily judged by task executors 360 who provide poorly defined tasks.

However, in some examples, the task issuer 360 may be involved in accepting the results. For example, if the example result validator 340 determines that there are no known images of the task objective 365 for comparison of the provided results, the example task issuer 360 may confirm or reject results provided by the task executor 370 as being of the correct task objective 365. If, for example, the task issuer 360 confirms the results provided by the task executor, subsequent performance of the same task and/or tasks concerning the same task objective 365 can be validated against the initial results that had been accepted by the task issuer 360.

In some examples, the reward issued to the task executor 370 is not a financial reward. For example, the reward issuer 350 may issue an achievement and/or a medal to the task executor based on the task performed and/or prior tasks that have been performed by the task executor 370. For example, the reward may indicate an achievement that the task executor 370 has made such as, for example, having photographed a threshold area of land (e.g., ten acres), having completed a threshold number of tasks (e.g., ten tasks completed), having completed a number of tasks in a given amount of time (e.g., five tasks completed in under two days), having provided a threshold quality of results (e.g., images of a threshold resolution, images having a low amount of blur, a model having a threshold number of vertices, etc.), etc.

The example task allocator 325 then marks the task as complete in the task database 320. (Block 890). Marking the task is complete and the task database 320 ensures that other task of executors 370 are not allocated the already-completed task. In some examples, the task may be re-enabled after a period of time (and/or at the direction of the task issuer 360) to enable the task to be performed again (e.g., if the task is to be re-performed on a weekly basis). The example process 800 of the illustrated example of FIG. 8 then terminates.

FIG. 9 is a flowchart representative of example machine-readable instructions 900 which may be executed to implement the example task execution facilitation system 310 of FIG. 3 to validate the result of the task. The example process 900 of the illustrated example of FIG. 9 begins when the example result validator 340 receives the completed result set from the example result processor 335 (e.g., Block 830 of FIG. 8). The example result validator acquires known images of the task objective 365. (Block 910). In examples disclosed herein, the known images of the task objective are retrieved from the third-party 380. That is, the known images are acquired from publicly available mapping services and/or other sources for images of the task objective 365. In some examples, the task issuer 360 provides the known images of the task objective 365. In some examples, the known images correspond to previous executions of the task and/or other tasks concerning the same task objective 365. The example result validator 340 determines a similarity score of the provided results of the task (e.g., the results from the task executor 370 received via the result receiver 330) to the known images. (Block 920). In examples disclosed herein, the result validator 340 determines the similarity based on color histograms of the images (e.g., the provided results against the known images of the task objective). However, any other past, present, and/or future approach to determining a level of similarity between images may additionally or alternatively be used.

The example result validator 340 determines whether the similarity score exceeds a first threshold similarity. (Block 930). In examples disclosed herein, the first threshold similarity is a high correlation threshold between the provided results and the known images (e.g., a similarity of greater than 90%). However, any other threshold may additionally or alternatively be used such as, for example, 99% image similarity. In examples disclosed herein, the high threshold (e.g., greater than 90% image similarity) is used to detect when the task executor 370, instead of properly performing the task, has copied images from a publicly available source (e.g., from the third-party) and supplied those images as their own results. If the example result validator 340 determines that the similarity score exceeds the first threshold similarity (e.g., the similarity score suggests that the task executor has copied images) (Block 930 returns a result of YES), the example result validator 340 identifies the results as invalid.

The example result validator 340 then determines whether the similarity score is below a second threshold similarity. (Block 940). In examples disclosed herein, the second threshold similarity is a low threshold similarity such as, for example, 10%. However, any other threshold similarly may additionally or alternatively be used such as, for example, 1%. Performing a check to determine whether the supplied results have a low threshold similarity to known images enables the result validator to detect when the task executor has provided results that do not match what would have been expected of the task objective 365. Such an approach ensures that the task execution facilitation system 310 rejects results that are not properly taken of the task objective 365. Thus, if the example result validator 340 determines that the similarity score is below the second threshold similarity (e.g., Block 940 returns a result of YES), the example result validator identifies the results as invalid.

The example result validator 340 determines one or more quality metrics of the provided results. (Block 950). In examples disclosed herein, the quality metric represents a number of edges detected in the provided images. An edge detection algorithm is used to detect a number of edges present in the provided image(s). However, any other approach to determining a quality of the provided results may additionally or alternatively be used such as, for example, detecting a number of vertices in a 3-D model, a quantification of blur in the provided images, determining a resolution of the provided images, etc. The example task executor compares the determined quality of the provided results to corresponding a quality threshold(s) provided in the task definition. (Block 960). If the quality of the provided results does not meet the specified quality threshold of the task definition (e.g., Block 960 returns a result of NO), the example result validator 340 identifies the results as invalid.

In some examples, the task definition indicates that a map and/or a model is to be provided. The example result validator 340 determines whether the provided and/or generated model and/or map include features set forth in the task definition. (Block 970). In some examples, the task issuer 360 may provide one or more listings and/or identifications of features that are expected to be provided in the map and/or model. For example, if the task objective is a cellular tower, the example task issuer 360 may indicate that the results must indicate include a wireless antenna and/or a shape and/or object that resembles a wireless antenna. Feature detection and/or feature similarity are used to detect the presence of the required feature in the map and/or model. If the model and/or map does not include such a feature, (e.g., Block 970 returns a result of NO), the example result validator 340 identifies the results as invalid.

The example result validator 340 determines whether metadata provided in the results satisfy the task definition. (Block 980). In some examples, the task definition may specify particular metadata characteristics of the images that are to be adhered to. For example, the task definition may specify a time of day that the images are to be captured. If metadata supplied as part of and/or in connection with the images included in the results does not adhere to the time of day restrictions set forth in the task definition, such results may be identified as invalid as not complying with the task definition. Moreover, any other property of the images and/or model may additionally or alternatively be used to facilitate validation such as, for example, a shutter speed of a camera, a geographic location at the time of capture of an image, etc. If the metadata does not adhere to the restrictions set forth in the task definition (e.g., Block 980 returns a result of NO), the example result validator 340 identifies the results as invalid.

If no validation errors had occurred throughout the process 900 the illustrated example of FIG. 9, the results are identified as valid. Validating the results using the example result validator 340 provides assurances to task executors that provide the results to the task execution facilitation system 310 that their results will not be arbitrarily judged by a task issuer 360. Conversely, the task issuers 360 are insured that they are not provided results that do not meet the quality standards and/or requirements of their task.

FIG. 10 is a block diagram of an example processor platform 1000 capable of executing the instructions of FIGS. 4, 5, 8, and/or 9 to implement the example task execution facilitation system 310 of FIG. 3. The processor platform 1000 can be, for example, a server, a personal computer, a mobile device (e.g., a cell phone, a smart phone, a tablet such as an iPad™), an Internet appliance, a set top box, or any other type of computing device.

The processor platform 1000 of the illustrated example includes a processor 1012. The processor 1012 of the illustrated example is hardware. For example, the processor 1012 can be implemented by one or more integrated circuits, logic circuits, microprocessors or controllers from any desired family or manufacturer. The hardware processor may be a semiconductor based (e.g., silicon based) device. In this example, the processor 1012 implements the example result processor 335, the example model generator 337, the example map generator 339, and/or the example result validator 340.

The processor 1012 of the illustrated example includes a local memory 1013 (e.g., a cache). The processor 1012 of the illustrated example is in communication with a main memory including a volatile memory 1014 and a non-volatile memory 1016 via a bus 1018. The volatile memory 1014 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1016 may be implemented by flash memory and/or any other desired type of memory device. Access to the main memory 1014, 1016 is controlled by a memory controller.

The processor platform 1000 of the illustrated example also includes an interface circuit 1020. The interface circuit 1020 may be implemented by any type of interface standard, such as an Ethernet interface, a universal serial bus (USB), and/or a PCI express interface. The example interface circuit 1020 of the illustrated example of FIG. 10 implements the example task receiver 315, the example task allocator 325, the example result receiver 330, the example reward issuer 350, and/or the example result provider 355.

In the illustrated example, one or more input devices 1022 are connected to the interface circuit 1020. The input device(s) 1022 permit(s) a user to enter data and/or commands into the processor 1012. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1024 are also connected to the interface circuit 1020 of the illustrated example. The output devices 1024 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 1020 of the illustrated example, thus, typically includes a graphics driver card, a graphics driver chip and/or a graphics driver processor.

The interface circuit 1020 of the illustrated example also includes a communication device such as a transmitter, a receiver, a transceiver, a modem and/or network interface card to facilitate exchange of data with external machines (e.g., computing devices of any kind) via a network 1026 (e.g., an Ethernet connection, a digital subscriber line (DSL), a telephone line, coaxial cable, a cellular telephone system, etc.).

The processor platform 1000 of the illustrated example also includes one or more mass storage devices 1028 for storing software and/or data. Examples of such mass storage devices 1028 include floppy disk drives, hard drive disks, compact disk drives, Blu-ray disk drives, RAID systems, and digital versatile disk (DVD) drives. The example mass storage 1028 of the illustrated example of FIG. 10 implements the example task database 320 and/or the example result database 345.

The coded instructions 1032 of FIGS. 4, 5, 8, and/or 9 may be stored in the mass storage device 1028, in the volatile memory 1014, in the non-volatile memory 1016, and/or on a removable tangible computer readable storage medium such as a CD or DVD.

From the foregoing, it will be appreciated that example methods, apparatus, and articles of manufacture have been disclosed that enables a crowd-sourced approach to completion of drone-related tasks. In examples disclosed herein, results provided by the task executor are validated against a task definition provided by the example task executor. In examples disclosed herein, the task issuer is not involved in validation of the results. Thus, the task executor can expect that their results will be validated only against those parameters defined in the task definition (e.g., will not be validated arbitrarily). Such an approach reduces the likelihood that results will be deemed invalid absent an actual failure of the results to comply with the corresponding task definition, thereby enabling the task executor to perform additional tasks (e.g., without having to repeat performance of tasks).

Example 1 includes an apparatus for facilitating execution of a task using a drone, the apparatus comprising a result receiver to access a result of a task performed by a task executor, the result including one or more images of a task objective captured by the task executor; a result validator to validate the result based on a task definition provided by a task issuer; a result provider to, in response to the validation of the result indicating that the result complies with the task definition, provide the result to the task issuer; and a reward issuer to, in response to the validation of the result indicating that the result complies with the task definition, issue a reward to the task executor.

Example 2 includes the apparatus of example 1, further including a task allocator to allocate the task to the task executor.

Example 3 includes the apparatus of example 2, wherein the task allocator is further to determine a number of task executors to whom the task has been allocated, and disable allocation of the task to the task allocator when a threshold maximum number of task executors have been allocated the task.

Example 4 includes the apparatus of example 1, wherein the result validator is further to determine a similarity score between the one or more images and known images of the task objective, and identify the result as invalid when the similarity score exceeds a first threshold similarity.

Example 5 includes the apparatus of example 4, wherein the first threshold similarity is at least a ninety percent similarity.

Example 6 includes the apparatus of example 4, wherein the result validator is further to identify the result as invalid when the similarity score does not meet a second threshold similarity lesser than the first threshold similarity.

Example 7 includes the apparatus of example 6, wherein the second threshold similarity is no more than a ten percent similarity.

Example 8 includes the apparatus of any one of examples 1 through 7, wherein the reward is a financial compensation.

Example 9 includes the apparatus of any one of examples 1 through 8, wherein the result provider is further to provide the result to a third party.

Example 10 includes the apparatus of example 9, wherein a portion of the reward issued to the task executor is provided by the third party.

Example 11 includes at least one non-transitory computer readable medium comprising instructions which, when executed, cause a machine to at least access a result of a task performed by a task executor, the result including one or more images of a task objective captured by the task executor; validate the result based on a task definition provided by a task issuer; and in response to the validation of the result indicating that the result complies with the task definition: provide the result to the task issuer; and issue a reward to the task executor.

Example 12 includes the at least one non-transitory computer readable medium of example 11, wherein the instructions, when executed, cause the machine to allocate the task to the task executor.

Example 13 includes the at least one non-transitory computer readable medium of example 12, wherein the instructions, when executed, cause the machine to at least determine a number of task executors to whom the task has been allocated; and not allocate the task to the task executor when a threshold maximum number of task executors have been allocated the task.

Example 14 includes the at least one non-transitory computer readable medium of example 11, wherein the instructions, when executed, cause the machine to validate the result by determining a similarity score between the one or more images and known images of the task objective; and identifying the result as invalid when the similarity score exceeds a first threshold similarity.

Example 15 includes the at least one non-transitory computer readable medium of example 14, wherein the first threshold similarity is at least a ninety percent similarity.

Example 16 includes the at least one non-transitory computer readable medium of example 14, wherein the instructions, when executed, cause the machine to identify the result as invalid when the similarity score does not meet a second threshold similarity lesser than the first threshold similarity.

Example 17 includes the at least one non-transitory computer readable medium of example 16, wherein the second threshold similarity is no more than a ten percent similarity.

Example 18 includes the at least one non-transitory computer readable medium of any one of examples 11 through 17, wherein the reward is a financial compensation.

Example 19 includes the at least one non-transitory computer readable medium of any one of examples 11 through 18, wherein the instructions, when executed, cause the machine to provide the result to a third party.

Example 20 includes the at least one non-transitory computer readable medium of example 19, wherein a portion of the reward issued to the task executor is provided by the third party.

Example 21 includes a method of for facilitating execution of a task using a drone, the method comprising accessing a result of a task performed by a task executor, the result including one or more images of a task objective captured by the task executor; validating, by executing an instruction with a processor, the result based on a task definition provided by a task issuer; in response to the validation of the result indicating that the result complies with the task definition: providing the result to the task issuer; and issuing a reward to the task executor.

Example 22 includes the method of example 21, further including allocating the task to the task executor.

Example 23 includes the method of example 22, further including determining a number of task executors to whom the task has been allocated; and not allocating the task to the task executor when a threshold maximum number of task executors have been allocated the task.

Example 24 includes the method of example 21, wherein the validating of the result includes determining a similarity score between the one or more images and known images of the task objective; and identifying the result as invalid when the similarity score exceeds a first threshold similarity.

Example 25 includes the method of example 24, wherein the first threshold similarity is at least a ninety percent similarity.

Example 26 includes the method of example 24, further including identifying the result as invalid when the similarity score does not meet a second threshold similarity lesser than the first threshold similarity.

Example 27 includes the method of example 26, wherein the second threshold similarity is no more than a ten percent similarity.

Example 28 includes the method of any one of examples 21 through 27, wherein the reward is a financial compensation.

Example 29 includes the method of any one of examples 21 through 28, further including providing the result to a third party.

Example 30 includes the method of example 29, wherein a portion of the reward issued to the task executor is provided by the third party.

Example 31 includes an apparatus for facilitating execution of a task using a drone, the apparatus comprising means for accessing a result of a task performed by a task executor, the result including one or more images of a task objective captured by the task executor; means for validating the result based on a task definition provided by a task issuer; means for providing, in response to the validation of the result indicating that the result complies with the task definition, the result to the task issuer; and means for issuing, in response to the validation of the result indicating that the result complies with the task definition, a reward to the task executor.

Example 32 includes the apparatus of example 31, further including means for allocating the task to the task executor.

Example 33 includes the apparatus of example 32, wherein the means for allocating is further to determine a number of task executors to whom the task has been allocated, and disable allocation of the task to the task allocator when a threshold maximum number of task executors have been allocated the task.

Example 34 includes the apparatus of example 31, wherein the means for validating is further to determine a similarity score between the one or more images and known images of the task objective, and identify the result as invalid when the similarity score exceeds a first threshold similarity.

Example 35 includes the apparatus of example 34, wherein the first threshold similarity is at least a ninety percent similarity.

Example 36 includes the apparatus of example 34, wherein the means for validating is further to identify the result as invalid when the similarity score does not meet a second threshold similarity lesser than the first threshold similarity.

Example 37 includes the apparatus of example 36, wherein the second threshold similarity is no more than a ten percent similarity.

Example 38 includes the apparatus of any one of examples 31 through 37, wherein the reward is a financial compensation.

Example 39 includes the apparatus of any one of examples 31 through 38, wherein the means for providing is further to provide the result to a third party.

Example 40 includes the apparatus of example 39, wherein a portion of the reward issued to the task executor is provided by the third party.

Although certain example methods, apparatus, and articles of manufacture have been disclosed herein, the scope of coverage of this patent is not limited thereto. On the contrary, this patent covers all methods, apparatus, and articles of manufacture fairly falling within the scope of the claims of this patent.

1-25. (canceled)

26. An apparatus for facilitating execution of a task using a drone, the apparatus comprising:
a result receiver to access a result of a task performed by a task executor, the result including one or more images of a task objective captured by the task executor;
a result validator to validate the result based on a task definition provided by a task issuer;
a result provider to, in response to the validation of the result indicating that the result complies with the task definition, provide the result to the task issuer; and
a reward issuer to, in response to the validation of the result indicating that the result complies with the task definition, issue a reward to the task executor.

27. The apparatus of claim 26, further including a task allocator to allocate the task to the task executor.

28. The apparatus of claim 27, wherein the task allocator is further to determine a number of task executors to whom the task has been allocated, and disable allocation of the task to the task allocator when a threshold maximum number of task executors have been allocated the task.

29. The apparatus of claim 26, wherein the result validator is further to determine a similarity score between the one or more images and known images of the task objective, and identify the result as invalid when the similarity score exceeds a first threshold similarity.

30. The apparatus of claim 29, wherein the first threshold similarity is at least a ninety percent similarity.

31. The apparatus of claim 29, wherein the result validator is further to identify the result as invalid when the similarity score does not meet a second threshold similarity lesser than the first threshold similarity.

32. The apparatus of claim 31, wherein the second threshold similarity is no more than a ten percent similarity.

33. The apparatus of claim 26, wherein the reward is a financial compensation.

34. The apparatus of claim 26, wherein the result provider is further to provide the result to a third party.

35. The apparatus of claim 34, wherein a portion of the reward issued to the task executor is provided by the third party.

36. At least one non-transitory computer readable medium comprising instructions which, when executed, cause a machine to at least:
access a result of a task performed by a task executor, the result including one or more images of a task objective captured by the task executor;
validate the result based on a task definition provided by a task issuer; and
in response to the validation of the result indicating that the result complies with the task definition:
provide the result to the task issuer; and
issue a reward to the task executor.

37. The at least one non-transitory computer readable medium of claim 36, wherein the instructions, when executed, cause the machine to allocate the task to the task executor.

38. The at least one non-transitory computer readable medium of claim 37, wherein the instructions, when executed, cause the machine to at least:
determine a number of task executors to whom the task has been allocated; and
not allocate the task to the task executor when a threshold maximum number of task executors have been allocated the task.

39. The at least one non-transitory computer readable medium of claim 36, wherein the instructions, when executed, cause the machine to validate the result by:
determining a similarity score between the one or more images and known images of the task objective; and
identifying the result as invalid when the similarity score exceeds a first threshold similarity.

40. The at least one non-transitory computer readable medium of claim 39, wherein the first threshold similarity is at least a ninety percent similarity.

41. The at least one non-transitory computer readable medium of claim 39, wherein the instructions, when executed, cause the machine to identify the result as invalid when the similarity score does not meet a second threshold similarity lesser than the first threshold similarity.

42. The at least one non-transitory computer readable medium of claim 41, wherein the second threshold similarity is no more than a ten percent similarity.

43. A method of for facilitating execution of a task using a drone, the method comprising:
accessing a result of a task performed by a task executor, the result including one or more images of a task objective captured by the task executor;
validating, by executing an instruction with a processor, the result based on a task definition provided by a task issuer;
in response to the validation of the result indicating that the result complies with the task definition:
providing the result to the task issuer; and
issuing a reward to the task executor.

44. The method of claim 43, further including:
allocating the task to the task executor;
determining a number of task executors to whom the task has been allocated; and
not allocating the task to the task executor when a threshold maximum number of task executors have been allocated the task.

45. The method of claim 43, wherein the validating of the result includes:
determining a similarity score between the one or more images and known images of the task objective; and
identifying the result as invalid when the similarity score exceeds a first threshold similarity.
